(19) United States
(12) Patent Application Publication
(10) Pub. No.: US 2026/0232136 A1
(43) Pub. Date: Aug. 13, 2026

(54) FOOD ROASTING APPARATUS

(71) Applicant: PoulTree LLC., Seattle, WA (US)

(72) Inventors: Anthony V. Smith, Seattle, WA (US); David L. Atchison, Seattle, WA (US); Nicolo A. Smith, Seattle, WA (US)

(73) Assignee: PoulTree LLC., Seattle, WA (US)

(21) Appl. No.: 19/048,641

(22) Filed: Feb. 7, 2025

(51) Int. Cl. A47J 37/06

(52) U.S. Cl. CPC A47J 37/0664

(57) ABSTRACT

The present application provides an improved food roasting apparatus and method of use thereof. The roasting apparatus includes a tailpiece section, a handle section, a rise section, a run section and a tip section. The tailpiece section is securable to a cooking fixture. An angle between the tailpiece section and the handle section is obtuse. An angle between the handle section and the rise section is obtuse. An angle between the rise section and the run section is obtuse. An angle between the run section and the tip section is obtuse.

### TECHNICAL FIELD

The present disclosure generally relates to a food roasting apparatus and method of use thereof.

### BACKGROUND

Roasting certain food in a cooking apparatus (e.g., oven, grill) may cause some parts of the food to be undercooked, while other parts to be overcooked. This is especially true when cooking a large and uneven piece of food, such as a whole chicken. A conventional method of cooking a whole chicken is to lay the whole chicken flat on a pan and place the pan in an oven. In this position, the dark meat is compressed against the white meat, forming a single thermal mass. This causes the breast to overcook before the thighs and legs of the chicken reach the optimal temperature for collagen breakdown. Therefore, an improved roasting apparatus and method are needed.

### SUMMARY

This application provides an improved roasting apparatus and method. The roasting apparatus includes a rod having a tailpiece section, a handle section, a rise section, a run section and a tip section. In some embodiments, the rod may be a single rod bent to form the sections. In some embodiments, the sections may be combined to form an integrated rod. The tailpiece section is secured into a cooking fixture, such as a cooking pan or an anchor. An angle between the tailpiece section and the handle section is obtuse, an angle between the handle section and the rise section is obtuse, an angle between the rise section and the run section is obtuse, and an angle between the run section and the tip section is obtuse.

The angles, angle ranges, lengths and length ranges in this application are approximations and are not meant to be interpreted as exact numerical values. In some embodiments, the rod is made from approximately ⅜ inch stainless steel. In some embodiments, the angle between the tailpiece section and the handle section is θ₁, and 150°≤θ₁≤165°. In some embodiments, the angle between the handle section and the rise section is θ₂, and 90.5°≤θ₂≤105°. In some embodiments, the angle between the rise section and the run section is θ₃, and 90.5°≤θ₃≤105°. In some embodiments, the angle between the run section and the tip section is θ₄, and 100°≤θ₄≤130°. It is noted that the numerical angles used in the description of the present application are approximate and that the numerical boundaries herein are not meant to be strict.

In some embodiments, the cooking fixture is a cooking pan, and the tailpiece section of the rod is secured into a handle of the cooking pan, so that the handle of the cooking pan and the handle section of the rod form a graspable handle. In some embodiments, there may be a score on the tailpiece section, and the tailpiece section is secured into the handle of the cooking pan according to the score. In some embodiments, the tailpiece section is inserted into the handle of the cooking pan so that tailpiece section extends a distance beyond a first end of the handle.

In some embodiments, the cooking fixture is an anchor and the tailpiece section is secured into a raised section of the anchor. In some embodiments, the anchor may include a raised section and a flat base section. In some embodiments, the flat base section is longer than the raised section. A bottom surface of the flat base section of the anchor may contact a surface in a cooking apparatus. In some embodiments, the raised section of the anchor has a trapezoidal shape, the flat base section of the anchor comprises three strips, and there is an obtuse angle, θ₅, between the raised section of the anchor and the flat base section of the anchor, where 130°≤θ₅≤140°. In some embodiments, both the raised section of the anchor and the flat base section of the anchor are trapezoidal shapes and there is an obtuse angle, θ₆, between the raised section of the anchor and the flat base section of the anchor. In some embodiments, the raised section of the anchor may include at least two holes at different heights for adjustable placement of the rod.

In some embodiments, the cooking fixture is a double anchor. The double anchor comprises a first raised section, a second raised section, and a flat base section, wherein a bottom surface of the flat base section of the double anchor contacts a surface in a cooking apparatus, and the first raised section, the second raised section and the flat base section are rectangularly shaped. In some embodiments, the flat base section of the double anchor is longer than the first raised section and the second raised section. The tailpiece section of a rod may be secured into a first raised section or a second raised section of the double anchor, and, at the same time, the tailpiece section of another rod may also be secured into a first raised section or a second raised section of the double anchor. The first raised section of the double anchor may include at least two holes at the same height and the second raised section of the double anchor may include at least two holes at a same height, wherein at least one rod is inserted into at least one hole in the double anchor. In some embodiments, the angle formed between the first raised section of the double anchor and the flat base section of the double anchor is θ₇. In some embodiments, the angle formed between the second raised section of the double anchor and the flat base section of the double anchor is θ₈.

### BRIEF DESCRIPTION OF THE DRAWINGS

Features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure. Furthermore, embodiments of this application can be freely combined with each other and aspects or steps of one embodiment can be freely introduced into another embodiment.

FIG. 1 is an illustration of a first view of a rod of a roasting apparatus in an embodiment of this application;

FIG. 2 is an illustration of a second view of the rod of the roasting apparatus in an embodiment of this application;

FIG. 3 is an illustration of the roasting apparatus in an embodiment of this application;

FIG. 4 is an illustration of an anchor in one embodiment of this application;

FIG. 5 is an illustration of an anchor in another embodiment of this application;

FIG. 6 is an illustration of a double anchor in an embodiment of this application.

### DETAILED DESCRIPTION

Embodiments of the disclosure are described more fully hereinafter with reference to the accompanying drawings, in which some embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

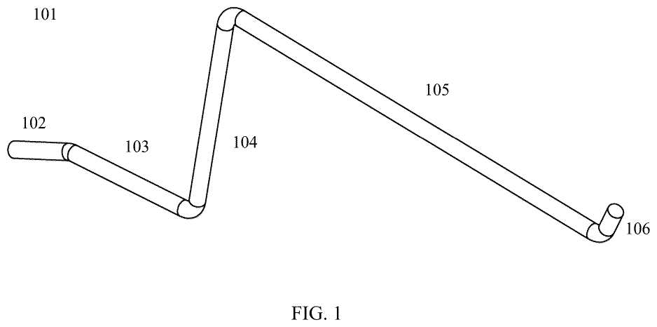

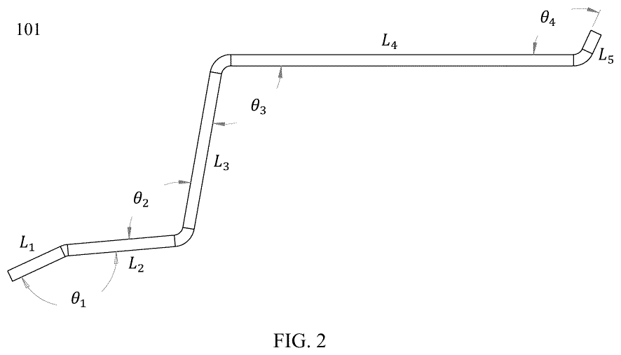

FIG. 1 illustrates a first view of a rod of a roasting apparatus according to an embodiment of this application. The rod 101 may be bent into five different sections, creating four angles between the sections (refer to FIG. 2 regarding the angles between the sections). The five sections comprise a tailpiece section 102, a handle section 103, a rise section 104, a run section 105, and a tip section 106. The tailpiece section of the rod 101 is inserted into a cooking fixture, such as a cooking pan or anchor, securing the rod 101 to the cooking fixture. When the cooking fixture is a cooking pan, such as a cast iron pan, the tailpiece section is inserted into a hole in the handle of the cooking pan. If the hole in the handle of the cooking pan is not large enough to accommodate the tailpiece section, the hole in the handle of cooking pan can be enlarged, for example, by a reamer.

Food, such as a whole chicken or another type of bird, is placed on the run section 105. For example, the rod 101 is inserted through the body cavity of a chicken so that the chicken rests on the run section 105 of the rod 101. The rise section 104 elevates the food. For example, in the case of cooking a whole chicken, the whole chicken is on the run section 105 and is elevated by the rise section 104, so that during cooking, hot air can move all around the whole chicken, including across the bottom of the chicken. The tip section 106 prevents the food from sliding off the rod 101. One of ordinary skill in the art would appreciate that certain sections of the rod may be omitted, for example, the rod does not need to be bent to include a tip section, wherein the function of the tip section could be instead performed by another apparatus, such as a clamp or an attachable tip. Furthermore, the rod does not need to be bent at all, and in some embodiments, the rod can comprise attachable and/or detachable pieces, such as an attachable/detachable tailpiece section, handle section, rise section, run section, and/or tip section.

The angles, angle ranges, lengths and length ranges in this application are approximations and are not meant to be interpreted as exact numerical values. FIG. 2 illustrates a second view of the rod 101 of the roasting apparatus in an embodiment of this application. The tailpiece section of the rod 101 has a length of L₁, the handle section of the rod 101 has a length of L₂, the rise section of the rod 101 has a length of L₃, the run section of the rod 101 has a length of L₄, and the tip section of the rod 101 has a length of L₅. The angle between the tailpiece section and the handle section is θ₁, the angle between the handle section and the rise section is θ₂, the angle between the rise section and the run section is θ₃, and the angle between the run section and the tip section is θ₄.

The angle between the tailpiece section and the handle section, θ₁, is set so that when the tailpiece section is inserted into a cooking pan, the handle section of the rod 101 and the handle of the cooking pan run substantially parallel to one another. This allows for preserving the functionality of a handle when the rod 101 is inserted into the cooking pan, so that the handle of the cooking pan and the handle section of the rod 101 can be grasped and function as a unitary handle. If θ₁ is not properly set, the handle section and the handle of the cooking pan will not be graspable. In some embodiments, θ₁ is an obtuse angle, for example, 150°≤θ₁≤165°. L₁ should be set so that the tailpiece section is long enough to pass through a hole in the handle of the cooking pan, so that the tailpiece section extends at least five millimeters beyond the hole. This allows for the tailpiece section to be reliably secured to the cooking pan. For example, L₁ may be in a range of greater than or equal to 1.5 inches and less than or equal to 2 inches. L₂ is set according to the length of the handle of the cooking pan, so that the handle section is close to the same length as the handle of a cooking pan. For example, a cooking pan with a 4 inch handle would correspond to an L₂ of 4 inches, and a cooking pan with a 6 inch handle would correspond to an L₂ of 6 inches.

The angle between the handle section and the rise section, θ₂, is set to provide the proper elevation to the food, while at the same time making sure that the food does not extend beyond a cooking pan, if the cooking pan is used as the cooking fixture. In some embodiments, θ₂ is obtuse, for example, 90.5°≤θ₂≤105°. L₃ is set to ensure that food is elevated to a proper height. If L₃ is too large, roasting apparatus may not fit into a standard cooking apparatus, such as an oven or a grill. In some embodiments L₃ may be in range of greater than or equal to 3 inches and less than or equal to 7 inches.

The angle between the rise section and the run section, θ₃, is set so that, when the rod 101 is inserted into the cooking fixture, the run section of the rod 101 is substantially parallel to a bottom surface of the cooking apparatus (e.g., substantially parallel to an oven rack), or so that the run section tilts slightly downwards (e.g., the run section tilts slightly towards the bottom surface of the cooking apparatus). This keeps food on the run section from sliding backwards to the handle section, and allows for the food to be secured by being pressed up against the tip section. In some embodiments, θ₃ is obtuse, for example, 90.5°≤θ₃≤105°. The angle between the run section and the tip section, θ₄, is set so that the food (e.g., whole chicken) is secured on the rod 101 and cannot slip off the rod 101. In some embodiments, θ₄ is obtuse, for example, 100°≤θ₄≤130°.

L₄ is set to ensure that the rod 101 can fit into the cooking apparatus (for example, if L₄ is too long, the roasting apparatus won't fit into an oven). In some embodiments, when the cooking fixture is a cooking pan, L₄ is set so that the food resting on the run section doesn't extend beyond the end of the cooking pan. In some embodiments, L₄ may be set to be in a range of greater than or equal to 3 inches and less than or equal to 12 inches. L₅ is set so that the tip section is long enough to secure the food to the rod 101. If L₅ is too short, the food may slip off the rod 101. For example, L₅ may be in a range of greater than or equal to 0.75 inches and less than or equal to 1.5 inches.

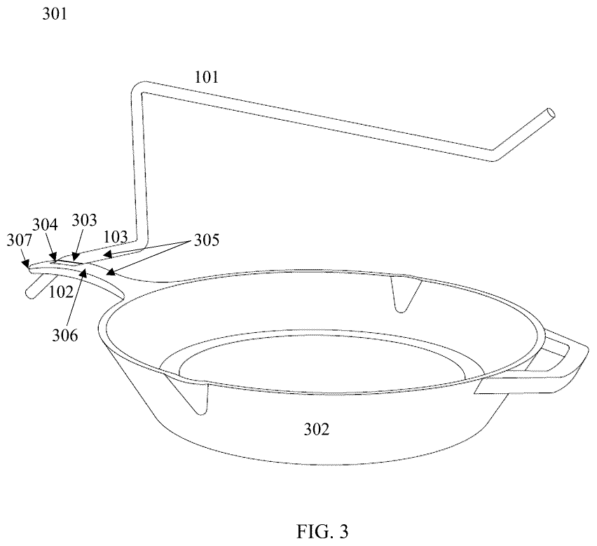

FIG. 3 is an illustration of roasting apparatus 301 in an embodiment of this application. The roasting apparatus 301 in FIG. 3 includes rod 101 and cooking pan 302. The cooking pan may be a cast iron pan. The rod 101 is inserted into a hole 304 in a handle 306 of the cooking pan 302, so that the handle section 103 of the rod 101 substantially parallels the handle 306 of the cooking pan 302. This allows the handle section 103 of the rod 101 and the handle 306 of the cooking pan 302 to form a graspable handle 305, so that the rod and cooking pan can be picked up via the graspable handle.

In some embodiments, there may be a score 303 on the tailpiece section 102, and the tailpiece section 102 is secured into the handle 306 of the cooking pan 302 according to the score 303, so that the score 303 aligns with the top surface of the handle 306 of the cooking pan 302. In some embodiments, the tailpiece section 102 is inserted into the handle 306 of the cooking pan 302 so that tailpiece section 102 extends a distance beyond a first end 307 of the handle 306 of the cooking pan 302.

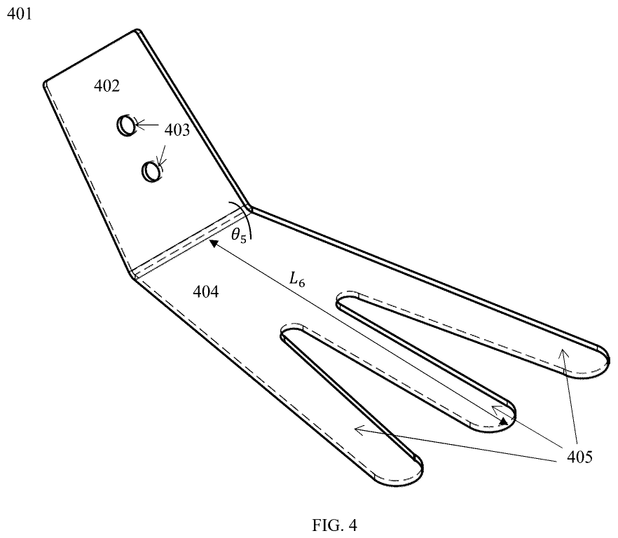

In some embodiments, the roasting apparatus may comprise a rod inserted into an anchor. An anchor in this application may also be referred to as a footrest. FIG. 4 is an illustration of an anchor in one embodiment of this application. Anchor 401 in FIG. 4 may also be referred to as a chicken footrest. Anchor 401 includes a trapezoidal raised section 402 and a flat base section 404, wherein a bottom surface of the flat base section 404 contacts a surface in a cooking apparatus, for example, the bottom surface of the flat base section 404 makes contact with an oven rack or a pan that will be placed onto an oven rack. In some embodiments, the flat base section 404 is longer than the raised section 402. The angle between the raised section of the anchor 402 and the flat base section of the anchor 404 is θ₅. θ₅ is set to stabilize the chicken footrest when the rod is inserted into one of the holes 403. In some embodiments, θ₅ is an obtuse angle, for example, 130°≤θ₅≤150°. The length of the flat base section of the anchor 404 is L₆. L₆ is set to stabilize the chicken footrest when a rod is inserted into one of the holes 403. If L₆ is set to be too small, the chicken footrest may turn over while the rod with the food is secured onto it. In some embodiments, L₆ is in a range of greater than or equal to 6 inches and less than or equal to 9 inches. In some embodiments L₆ is set at 8 inches plus or minus half an inch.

The raised section of the anchor 402 includes two holes 403 at different heights for adjustable placement of the rod. This allows for either raising the food, by inserting the rod into the top hole of the two holes 403, or to lower the food by inserting the rod into the bottom hole of the two holes 403. In some embodiments, it may be desirable to utilize the top hole of the anchor, for example, to increase the clearance between the food on the rod and the surface of the cooking apparatus. Alternatively, it may be desirable to utilize the bottom hole of the anchor to, for example, to lower the clearance between the food on the rod and the surface of the cooking apparatus, allowing for the roasting apparatus fit into a smaller oven cavity. The flat base section of the anchor 404 includes three strips 405.

One of ordinary skill in the art would appreciate that instead of two holes, one may be placed on the chicken footrest, or more than two may be placed. Likewise, one of ordinary skill in the art would appreciate that the locations of the holes 403 on the raised section of the anchor 402 may also be different from what is illustrated in FIG. 4. Similarly, a person of ordinary skill in the art would appreciate that more than three strips can be used for the chicken footrest and that the locations of those strips may also be different to what is illustrated in FIG. 4. These types of modifications fall within the embodiments of this application.

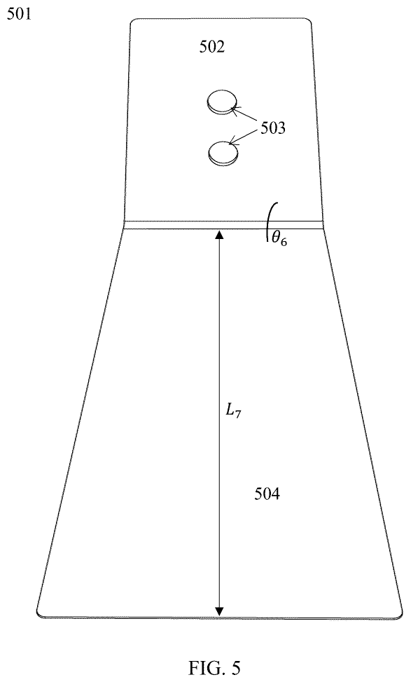

FIG. 5 is an illustration of an anchor in another embodiment of this application. Anchor 501 includes two trapezoidal sections, a raised section 502 and a flat base section 504, wherein a bottom surface of the flat base section 504 contacts a surface in a cooking apparatus. For example, the bottom surface of the flat base section 504 makes contact with an oven rack, or a pan that will be placed onto an oven rack. In some embodiments, the flat base section 504 is longer than the raised section 502. The angle between the raised section 502 and the flat base section 504 is θ₆. θ₆ is set to stabilize the chicken footrest when a rod is inserted into one of the holes 503. In some embodiments, θ₆ is an obtuse angle, for example, 130°≤θ₆≤150°. The length of the flat base section 504 section is L₇. L₇ is set to stabilize the footrest when a rod is inserted into one of the holes 503. If L₇ is set to be too small, the chicken footrest may turn over when the rod with the food is secured into it. In some embodiments, L₇ may be in a range of greater than or equal to 6 inches and less than or equal 9 inches.

The raised section 502 includes two holes 503 at different heights for adjustable placement of the rod. For example, the tailpiece of the rod may be inserted into the top hole of the two holes 503, or the rod may be inserted into the bottom hole of the two holes 503. One of ordinary skill in the art would appreciate that instead of two holes, one may be placed on the raised section of the anchor 502, or more than two may be placed. Likewise, one of ordinary skill in the art would appreciate that the locations of the holes 503 on the raised section 502 may also be different from what is illustrated in FIG. 5. These types of modifications fall within the embodiments of this application.

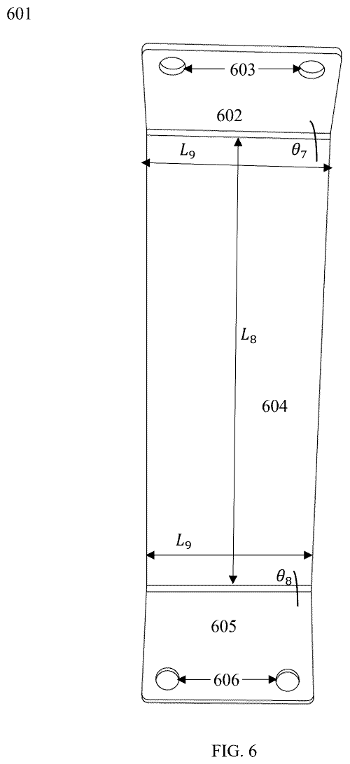

FIG. 6 is an illustration of a double anchor 601 in some embodiments of this application. Double anchor 601 includes three sections, a rectangular first raised section 602, a rectangular second raised section 605 and a rectangular flat base section 604. In some embodiments, the flat base section of the double anchor is longer than the first raised section 602 and the second raised section 605. A bottom surface of the flat base section 604 contacts a surface in a cooking apparatus. For example, the bottom surface of the rectangular flat base section 604 makes contact with an oven rack, or a pan that will be placed onto an oven rack. The angle between the first raised section 602 and the flat base section 604 is θ₇. The angle between the second raised section 605 and the flat base section 604 is θ₈. In some embodiments, θ₇, and θ₈ are obtuse angles, for example, 130°≤θ₇≤150°, and 130°≤θ₈≤145°. The length of the flat base section 604 is L ₈. L₈ is set to stabilize the footrest when a rod is inserted into the one of the holes in the footrest. If L₈ is set to be too small, the chicken footrest may tip over when the rod with the food is secured onto it. In some embodiments, L₈ is set to be in a range of greater than or equal to 6 inches and less than or equal to 9 inches. The width of the rectangular first raised section 602, the rectangular second raised section 605, and the rectangular flat base section 604 is L₉. If the width L₉ is too narrow, the double anchor 601 may not be able to accommodate both a first rod with food and a second rod with food.

In some embodiments, the first raised section 602 includes two holes 603 at a same height. In some embodiments, the second raised section 605 includes two holes 606 at a same height. The tailpiece of the rod may be inserted into any of the holes 603 or 606. One of ordinary skill in the art would appreciate that instead of two holes on the first raised section and the second raised section, only one may be placed on each raised section, or more than two may be placed on each raised section. Likewise, one of ordinary skill in the art would appreciate that the locations of holes 603 and 606 may also be different from what is illustrated in FIG. 6. Furthermore, a plurality of rods may be inserted into the double anchor at the same time. These types of modifications fall within the embodiments of this application.

1. A roasting apparatus comprising:
a rod that includes a tailpiece section, a handle section, a rise section, a run section and a tip section, wherein
an angle between the tailpiece section and the handle section is obtuse,
an angle between the handle section and the rise section is obtuse,
an angle between the rise section and the run section is obtuse, and
an angle between the run section and the tip section is obtuse.

2. The roasting apparatus according to claim 1, wherein the tailpiece section is securable to a cooking fixture, the cooking fixture is a cooking pan, and the tailpiece section is secured into a handle of the cooking pan.

3. The roasting apparatus according to claim 2, wherein there is a score on the tailpiece section, and the tailpiece section is secured into the handle of the cooking pan according to the score.

4. The roasting apparatus according to claim 2, wherein the tailpiece section is inserted into the handle of the cooking pan so that tailpiece section extends a distance beyond a first end of the handle of the cooking pan.

5. The roasting apparatus according to claim 1, wherein the tailpiece section is securable to a cooking fixture, the cooking fixture is an anchor, the tailpiece section is secured into a raised section of the anchor, and
the anchor comprises the raised section and a flat base section, wherein the bottom surface of the flat base section makes contact with a surface in a cooking apparatus.

6. The roasting apparatus according to claim 5, wherein the raised section of the anchor and the flat base section of the anchor are trapezoidal shapes.

7. The roasting apparatus according to claim 6, wherein there is an obtuse angle between the raised section of the anchor and the flat base section of the anchor.

8. The roasting apparatus according to claim 5, wherein the raised section of the anchor has a trapezoidal shape and the flat base section of the anchor comprises three strips.

9. The roasting apparatus according to claim 8, wherein there is an obtuse angle between the raised section of the anchor and the flat base section of the anchor.

10. The roasting apparatus according to claim 1, wherein the rod is made from approximately ⅜ inch stainless steel.

11. The roasting apparatus according to claim 1, wherein the angle between the tailpiece section and the handle section is θ₁, and 150°≤θ₁≤165°.

12. The roasting apparatus according to claim 1, wherein the angle between the handle section and the rise section is θ₂, and 90.5°≤θ₂≤105°.

13. The roasting apparatus according to claim 1, wherein the angle between the rise section and the run section is θ₃, and 90.5°≤θ₃≤105°.

14. The roasting apparatus according to claim 1, wherein the angle between the run section and the tip section is θ₄, and 100°≤θ₄≤130°.

15. The roasting apparatus according to claim 7, wherein the flat base section of the anchor is longer than the raised section of the anchor.

16. The roasting apparatus according to claim 9, wherein the angle formed between the raised section of the anchor and the flat base section is θ₅, and 130°≤θ₅≤140°.

17. The roasting apparatus according to claim 16, wherein the raised section of the anchor comprises at least two holes at different heights for adjustable placement of the rod.

18. The roasting apparatus according to claim 7, wherein the raised section of the anchor comprises at least two holes at different heights for adjustable placement of the rod.

19. The roasting apparatus according to claim 1, wherein the tailpiece section is securable to a cooking fixture, the cooking fixture is a double anchor, the tailpiece section is secured into a first raised section or a second raised section of the double anchor, and
the double anchor comprises the first raised section, the second raised section, and a flat base section, wherein
a bottom surface of the flat base section contacts a surface in a cooking apparatus, and
the first raised section, the second raised section and the flat base section are rectangularly shaped.

20. (canceled)

21. An apparatus to elevate food for roasting, comprising:
a rod bent into a tailpiece section, a handle section, a rise section, a run section and a tip section, and
a cooking fixture, wherein
an angle between the tailpiece section and the handle section is obtuse,
an angle between the handle section and the rise section is obtuse,
an angle between the rise section and the run section is obtuse,
an angle between the run section and the tip section is obtuse, and
the tailpiece section is secured to the cooking fixture.
